(19) United States
(12) Patent Application Publication
(10) Pub. No.: US 2012/0316978 A1
(43) Pub. Date: Dec. 13, 2012

(54) INVENTORY MANAGEMENT AND CONTROL OF A JEWELRY COLLECTION

(75) Inventors: Michael Wayne SHORE, Dallas, TX (US); Lee MILLER, Greenwich, CT (US)

(73) Assignee: MY JEWELRY BOX, LLC, Greenwich, CT (US)

(21) Appl. No.: 13/489,524

(22) Filed: Jun. 6, 2012

Related U.S. Application Data
(60) Provisional application No. 61/494,589, filed on Jun. 8, 2011.

(51) Int. Cl. G06Q 10/08; G06Q 30/06

(52) U.S. Cl. 705/26.1; 705/28

(57) ABSTRACT

A method, system and computer readable media for inventory management and control of a jewelry collection includes the steps of providing a jewelry tracking identifier for at least one piece of jewelry and providing a user identifier of at least one user. The method further includes tracking a usage by the at least one user of the at least one piece of jewelry via the jewelry tracking identifier via the user identifier, and determining a balance of time remaining of the at least one user based at least in part upon the tracked usage.

### BACKGROUND OF THE INVENTION

An embodiment of the device relates generally to a method, system and computer readable media for inventory management and control of a jewelry collection or collections. Clients of a jewelry management service or company own a share or fractional ownership of either the entire collection or individual pieces within the collection and have equity in given pieces, a sub-set of the jewelry collection or the entire collection. This fractional ownership gives the client the right to use identified pieces of that jewelry for a set number of days a year. One of the embodiments herein provides for a tracking and inventory control for the management and control of the collection. In another embodiment which may be used in conjunction with the first embodiment a tracking system and methodology for the delivery of pieces is provided.

### BRIEF SUMMARY OF THE INVENTION

One embodiment relates to a method for inventory management and control of a jewelry collection, the first embodiment includes providing a jewelry tracking identifier for at least one piece of jewelry and providing a user identifier of at least one user. A user is someone the system recognizes as having an ownership interest, or time share in a given piece of jewelry, a sub-set of the jewelry collection or in the entire collection. The method further includes tracking a usage, by the at least one user of the at least one piece of jewelry via the jewelry tracking identifier and the user identifier, and determining a balance of time remaining of the at least one user based at least in part upon the tracked usage.

Another embodiment relates to a method for inventory management and control of a jewelry collection, the second embodiment includes, providing a jewelry tracking identifier for least one piece of jewelry, providing a fractional owner identifier of at least one fractional owner for the at least one piece of jewelry and tracking a fractional owner usage of the at least one piece of jewelry by the at least one fractional owner via the jewelry tracking identifier and the fractional owner identifier. This method further includes tracking an inventory of the at least one piece of jewelry, and determining a balance of time remaining based upon the tracked fractional owner usage.

A further embodiment relates to a system for inventory management and control of a jewelry collection, the system having, a display that provides at least one user with inventory management and control of jewelry, and a processor communicably coupled to the display. The processor, provides a jewelry tracking identifier of at least one piece of jewelry, provides a fractional owner identifier of at least one fractional owner and tracks a fractional owner's usage of the at least one piece of jewelry by the at least one fractional owner via the jewelry tracking identifier and the fractional owner identifier. This embodiment additionally tracks an inventory of the at least one piece of jewelry and determines a balance of time remaining, or usage based upon the tracked fractional owner's available and consumed usage.

Yet a further embodiment relates to a system for inventory management and control of a jewelry collection, the system having, a display that provides at least one user with inventory management and control of a jewelry collection, and a processor communicably coupled to the display. The processor provides a jewelry tracking identifier of at least one piece of jewelry, provides a fractional owner identifier of at least one fractional owner and tracks a fractional owner usage of the at least one piece of jewelry by the at least one fractional owner via the jewelry tracking identifier and the fractional owner identifier. Additionally, this embodiment tracks an inventory location of the at least one piece of jewelry and determines a balance of time remaining based upon the tracked fractional owner usage.

A still further embodiment relates to a computer usable medium having computer readable instructions for controlling a computer to enable inventory management and control of a jewelry collection executing the steps of, providing a jewelry tracking identifier of at least one piece of jewelry, providing a fractional owner identifier of at least one fractional owner and tracking location information of the at least one piece of jewelry based upon the jewelry tracking identifier. Additionally the instructions includes determining a storage cost of the at least one piece of jewelry apportioned to the at least one fractional owner based upon the fractional owner identifier based upon the tracked location information.

### BRIEF DESCRIPTION OF THE DRAWINGS

The foregoing summary, as well as the following detailed description of preferred embodiments, will be better understood when read in conjunction with the appended drawings. For the purpose of illustration, these are shown in the drawings embodiments which are presently preferred. It should be understood, however, that the device is not limited to the precise arrangements and instrumentalities shown.

FIG. 1 is a schematic flow diagram which illustrates a logic flow of the preferred method of the first embodiment;

FIG. 2 is a schematic flow diagram which illustrates a logic flow of the preferred method of the first embodiment;

FIG. 3 is a schematic flow diagram which illustrates a logic flow of the preferred method of the second embodiment;

FIG. 4 is a schematic flow diagram which illustrates a logic flow of the preferred method of the second embodiment;

FIG. 5 is a schematic flow diagram which illustrates a logic flow of the preferred method of the second embodiment;

FIG. 6 illustrates a system of the second preferred embodiment;

FIG. 7 illustrates a system of the third preferred embodiment;

FIG. 8 illustrates a system of the third preferred embodiment;

FIG. 9 illustrates a system of the fourth preferred embodiment;

FIG. 10 illustrates a computer readable media of the fifth preferred embodiment;

FIG. 11 illustrates a computer readable media of the fifth preferred embodiment;

FIG. 12 illustrates a computer readable media of the fifth preferred embodiment;

FIG. 13 illustrates a computer readable media of the fifth preferred embodiment;

FIG. 14 illustrates a computer readable media of the fifth preferred embodiment;

FIG. 15 illustrates a computer readable media of the fifth preferred embodiment;

FIG. 16 is a system diagram of an embodiment;

FIG. 17 is an administrator screen shot;

FIG. 18 is a user screen shot;

FIG. 19 is a user screen shot;

FIG. 20 is a user screen shot;

FIG. 21 is a system diagram of a sixth preferred embodiment;

FIG. 22 is a system diagram of a seventh preferred embodiment;

FIG. 23 is a system diagram of an eighth preferred embodiment;

FIG. 24 is a partial system diagram of the processor in accordance with preferred embodiments;

FIG. 25 is a partial system diagram of the processor in accordance with preferred embodiments;

FIG. 26 is a partial system diagram of the processor in accordance with preferred embodiments; and

FIG. 27 is a partial system diagram of the processor in accordance with preferred embodiments.

### DETAILED DESCRIPTION OF THE INVENTION

Although the present embodiments illustrate the management and control of a jewelry collection, other valuable fractionally owned assets may as well be included. Other objectives and advantages of each of the embodiments will be apparent from the following description and drawings herein.

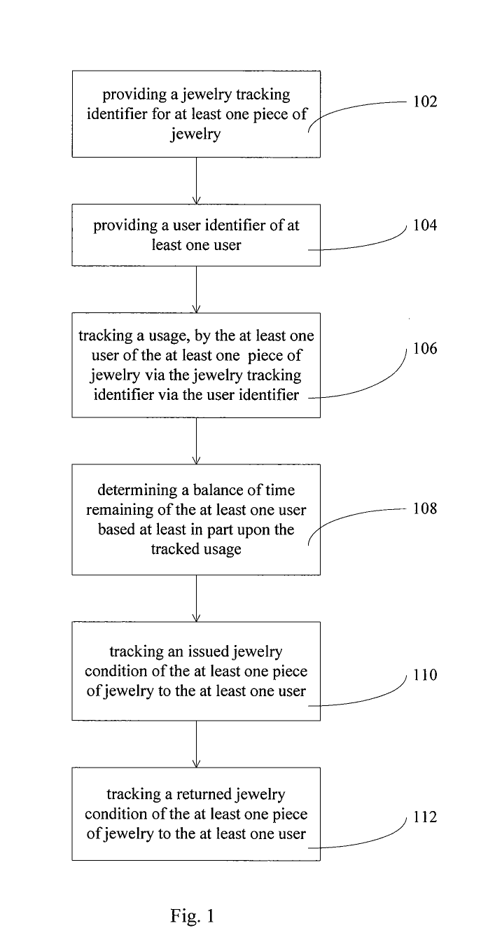

FIG. 1 is a schematic flow diagram which illustrates a method for inventory management and control of a jewelry collection, the first preferred embodiment includes providing, 102, a jewelry tracking identifier for at least one piece of jewelry. The jewelry tracking identifier is preferably unique and can be a name, number, image, code, combinations thereof, or the like. The jewelry tracking identifier is preferably stored in memory and allows the associated piece of jewelry to be tracked within the system. The jewelry tracking identifier may also be physically provided in order to match up the jewelry with the jewelry tracking identifier in the system, such as by a tag, engraving, machine readable indicia or the like, and is placed on the respective jewelry, on a container or display case of the jewelry, or the like. Similarly, the method includes providing, 104, a user identifier of at least one user. The user identifier is also preferably stored in memory and can be the user's name, or some other unique alphanumeric code, digital certificate, or the like associated with the particular user.

The method further includes tracking, 106, a usage, by the at least one user of the at least one piece of jewelry via the jewelry tracking identifier and the user identifier. In practice, for example, a user may check out a piece of jewelry, and the transaction will be logged by recording at least the date, the user identifier of the user, and the jewelry tracking identifier of the jewelry being checked out by the user. The method further includes determining, 108, a balance of time remaining of the at least one user based at least in part upon the tracked usage. The balance of time remaining may be determined by, for example, ascertaining the number of hours, days, weeks or the like that have passed since the jewelry was checked out by the user, according to the data gathered above, and subtracting this value from a predetermined amount of time that a user is permitted to be in possession of the jewelry. In another example, the balance of time remaining can be determined by ascertaining the time remaining before a predetermined time and/or date that the user is required to check in the jewelry.

This embodiment of the method may further include tracking, 110, an issued jewelry condition of the at least one piece of jewelry to the at least one user, and tracking, 112, a returned jewelry condition of the at least one piece of jewelry to the at least one user. For example, prior to the user's taking possession of the jewelry, an operator of the jewelry inventory management or the like will observe or determine the condition of the jewelry and log the condition along with the jewelry tracking identifier, the user identifier, and the like. Once the user returns the jewelry, the condition will again be determined and logged, and can be compared with the condition of the jewelry to, for example, assess any damage for which the user may be responsible.

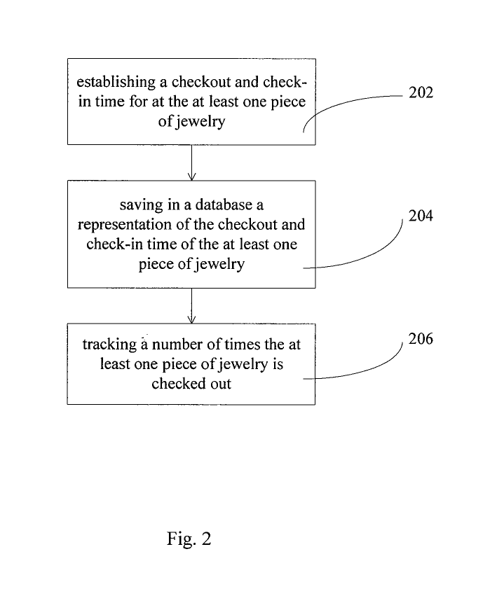

Additionally as illustrated in FIG. 2, the method may employ tracking an inventory of multiple pieces of jewelry, establishing, 202, a checkout and check-in time for the at least one piece of jewelry, saving, 204, in a database a representation of the checkout and check-in time of the at least one piece of jewelry, and tracking, 206, a number of times the at least one piece of jewelry is checked out. In this method the at least one user may be a fractional owner of the at least one piece of jewelry.

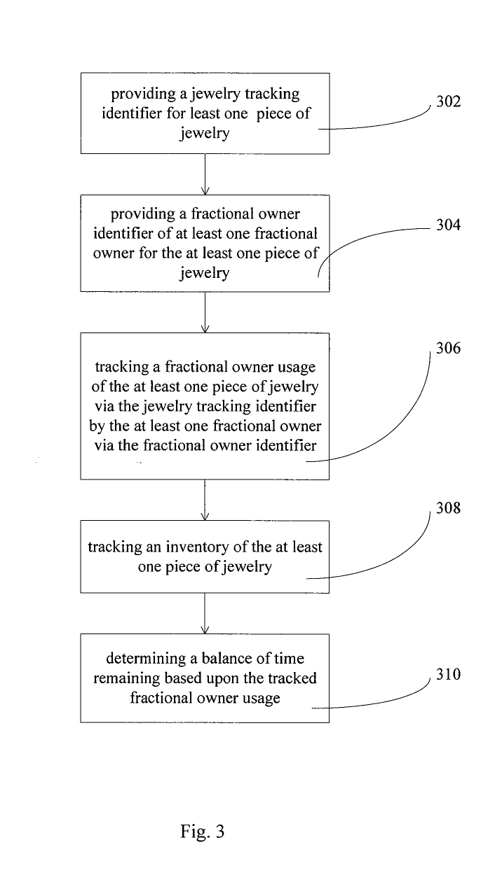

FIG. 3 illustrates a second preferred embodiment that provides a method for inventory management and control of a jewelry collection, the second embodiment includes, providing, 302, a jewelry tracking identifier for least one piece of jewelry, providing, 304, a fractional owner identifier of at least one fractional owner for the at least one piece of jewelry and tracking, 306, a fractional owner usage of the at least one piece of jewelry by the at least one fractional owner via the jewelry tracking identifier and the fractional owner identifier. The fractional owner identifier is also preferably stored in memory and can be the fractional owner's name, or some other unique alphanumeric code, digital certificate, or the like associated with the particular fractional owner. Preferably the fractional owner's ownership interest (by percentage or the like) in the jewelry is also associated with the fractional owner identifier. Fractional owner usage is preferably correlated with the ownership interest by the fractional owner. For example, a 30% owner of a piece of jewelry is entitled to use of the jewelry for only 30% of a predetermined time period (month, year, or the like), although the usage can also be negotiated in other ways. This method further includes tracking, 308, an inventory of the at least one piece of jewelry, and determining, 310, a balance of time remaining for use by the fractional owner based upon the tracked fractional owner usage.

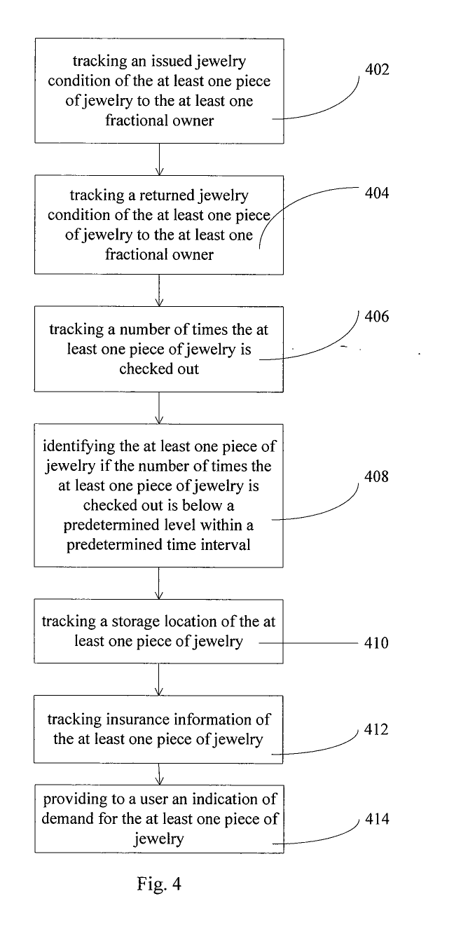

FIG. 4 illustrates that the method may further include tracking, 402, an issued jewelry condition of the at least one piece of jewelry to the at least one fractional owner, and tracking, 404, a returned jewelry condition of the at least one piece of jewelry to the at least one fractional owner. Additionally the method may employ tracking, 406, a number of times the at least one piece of jewelry is checked out and identifying, 408, the at least one piece of jewelry if the number of times the at least one piece of jewelry is checked out is below a predetermined level within a predetermined time interval, for example, if a piece of jewelry is checked out less than twenty times a year. The method may further include tracking, 410, a storage location of the at least one piece of jewelry and tracking, 412, insurance information of the at least one piece of jewelry and providing, 414, to a user an indication of demand for the at least one piece of jewelry. Demand is preferably determined by the stored usage data over a period of time prior to presentation of the indication of demand. In this way the demand appears is as up-to-date as possible. Insurance information can include policy coverage, payment amounts, scheduled payments, the name of the policy holder, contact information of the insurer, and the like. The insurance information can be stored locally or at a remote storage location, can be retrieved from a database provided by the insurer, or the like.

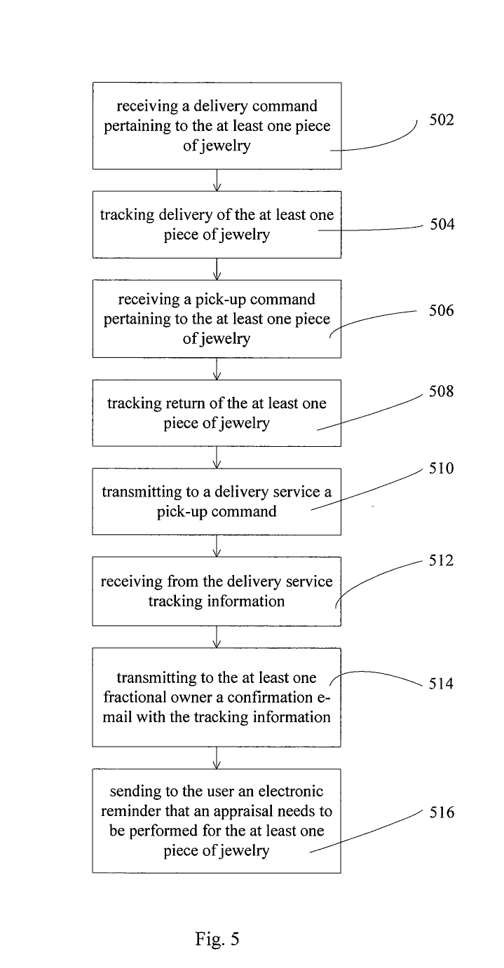

As FIG. 5 illustrates, this method may further include receiving, 502, a delivery command pertaining to the at least one piece of jewelry, tracking, 504, delivery of the at least one piece of jewelry, receiving, 506, a pick-up command pertaining to the at least one piece of jewelry and tracking, 508, return of the at least one piece of jewelry. Delivery and pick-up commands may be input by an administrator of the system, customers, or the like. A customer, for example, may send a delivery command via email, text message, or the like when requesting use of a piece of jewelry. The system stores the commands in memory, including the party issuing the command, the date and time of the command, the jewelry pieces associated with the command, and the like. The method may further include transmitting, 510, to a delivery service a pick-up command, receiving, 512, from the delivery service tracking information, and thereafter transmitting, 514, to the at least one fractional owner a confirmation e-mail with the tracking information and sending, 516, to the user an electronic reminder than an appraisal needs to be performed for the at least one piece of jewelry. The tracking information is preferably provided by the third party delivery service, which provides tracking information to the fractional owner for shipment and delivery. The tracking information, which may include a unique tracking number, is preferably also recorded in memory for logging. Electronic reminders, such as those for needed appraisals, are preferably automatically generated and transmitted by the system, although reminders may also be manually generated. Scheduling of reminders and due dates can also be manually entered based on agreements or the like, or may be automatically generated from check-out dates or other triggers.

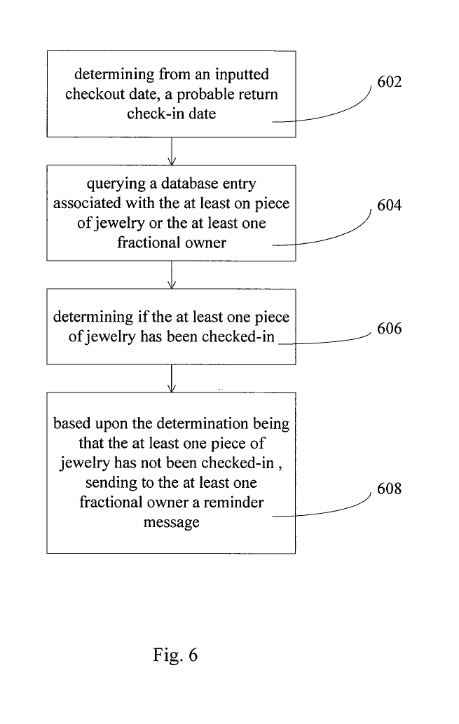

FIG. 6 illustrates that the method may provide determining, 602, from an inputted checkout date, a probable return check-in date, querying, 604, a database entry associated with the at least one piece of jewelry or the at least one fractional owner, and determining, 606, if the at least one piece of jewelry has been checked-in, and based upon the determination being that the at least one piece of jewelry has not been checked-in and sending, 608, to the at least one fractional owner a reminder message.

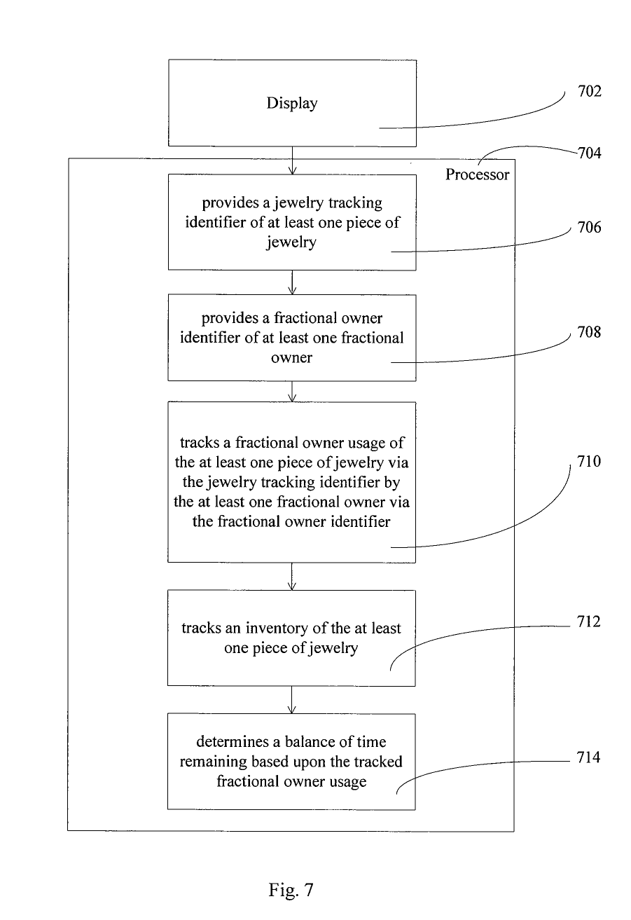

FIG. 7 illustrates a third preferred embodiment that employs a system for inventory management and control of a jewelry collection, the system having, a display, 702, that provides at least one user with inventory management and control of a jewelry collection, and a processor, 704, communicably coupled to the display, wherein the processor provides, 706, a jewelry tracking identifier of at least one piece of jewelry, provides, 708, a fractional owner identifier of at least one fractional owner, tracks, 710, a fractional owner usage of the at least one piece of jewelry by the at least one fractional owner via the jewelry tracking identifier and the fractional owner identifier, tracks, 712, an inventory of the at least one piece of jewelry, and determines, 714, a balance of time remaining based upon the tracked fractional owner usage.

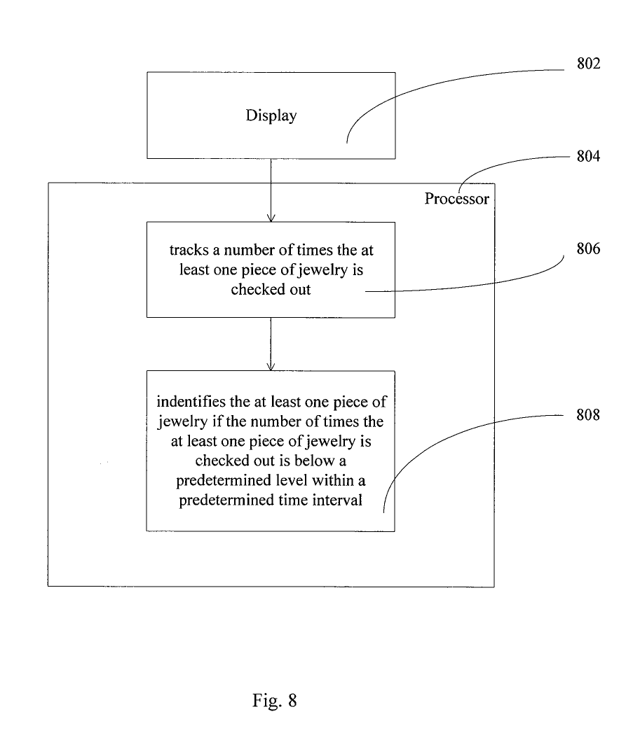

Additionally, FIG. 8 illustrates that the processor, 804, further tracks, 806, a number of times the at least one piece of jewelry is checked out and may indentify, 808, the at least one piece of jewelry if the number of times the at least one piece of jewelry is checked out is below a predetermined level within a predetermined time interval.

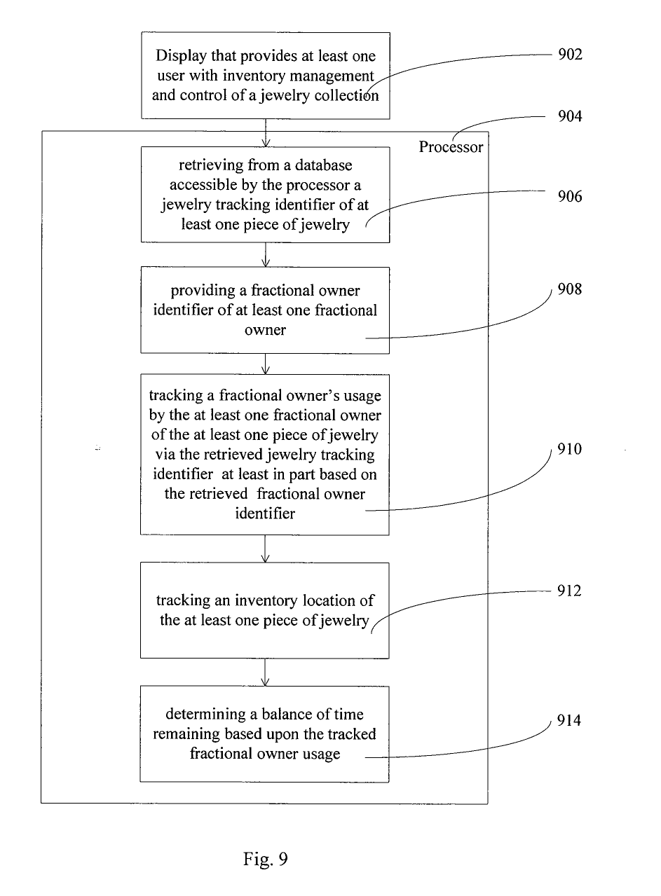

FIG. 9 illustrates a fourth embodiment that may employ a system for inventory management and control of a jewelry collection, the system having, a display, 902, that provides at least one user with inventory management and control of a jewelry collection, and a processor, 904, communicably coupled to the display, wherein the processor. The processor executes the steps of retrieving, 906, from a database accessible by the processor a jewelry tracking identifier of at least one piece of jewelry, providing, 908, a fractional owner identifier of at least one fractional owner and tracking, 910, a fractional owner's usage by the at least one fractional owner of the at least one piece of jewelry via the retrieved jewelry tracking identifier at least in part based on the retrieved fractional owner identifier. The processor additionally executes the steps of tracking 912 an inventory location of the at least one piece of jewelry and determining 914 a balance of time remaining based upon the tracked fractional owner usage.

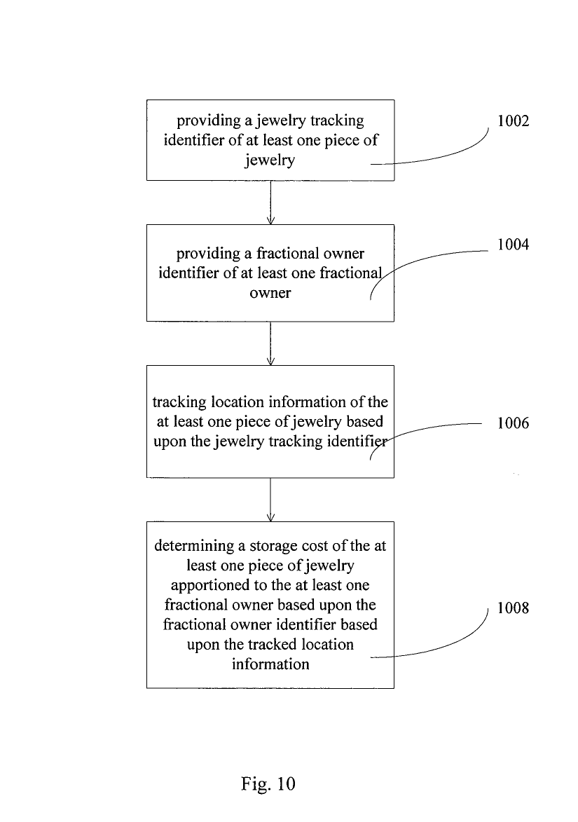

FIG. 10 illustrates a fifth embodiment that may employ a computer usable medium having computer readable instructions for controlling a computer to enable inventory management and control of a jewelry collection and executing the steps of: providing, 1002, a jewelry tracking identifier of at least one piece of jewelry, providing, 1004, a fractional owner identifier of at least one fractional owner, tracking, 1006, location information of the at least one piece of jewelry based upon the jewelry tracking identifier, and determining, 1008, a storage cost of the at least one piece of jewelry apportioned to the at least one fractional owner based upon the fractional owner identifier based upon the tracked location information. For example, the piece of jewelry may be stored at a dedicated remote site requiring payment for use of the storage facility. The system associates in memory the storage location with the jewelry tracking identifier, such as in a look-up table or the like. The system can also be used to calculate and divide the storage cost among fractional owners based on ownership interest, usage, or the like.

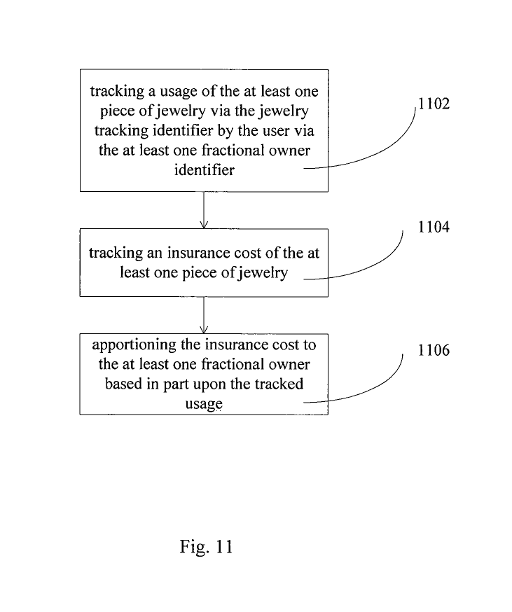

FIG. 11 illustrates the steps of tracking, 1102, a usage of the at least one piece of jewelry via the jewelry tracking identifier by the user via the at least one fractional owner identifier, tracking, 1104, an insurance cost of the at least one piece of jewelry, and apportioning, 1106, the insurance cost to the at least one fractional owner based in part upon the tracked usage may be employed. For example, the system may assign a higher portion of the insurance cost to a user that uses the piece of jewelry more frequently.

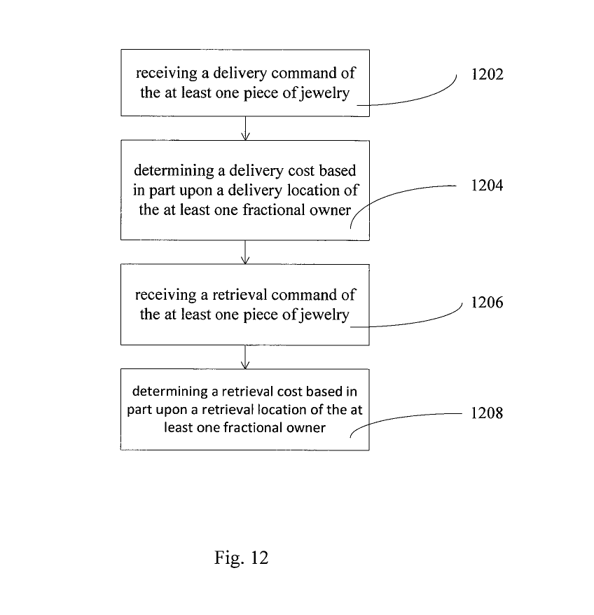

Additionally, FIG. 12 illustrates that the computer may execute the steps of receiving, 1201, a delivery command of the at least one piece of jewelry, and determining, 1204, a delivery cost based in part upon a delivery location of the at least one fractional owner. Further the following steps may be executed: receiving, 1206, a retrieval command of the at least one piece of jewelry, and determining, 1208, a retrieval cost based in part upon a retrieval location of the at least one fractional owner. For example, the cost to pick-up and ship the piece of jewelry via a carrier may be greater depending on the distance of the jewelry storage site from the fractional owner. Thus, the computer can calculate the cost based on, for example, zip code, city information, or the like from known fees provided by carriers.

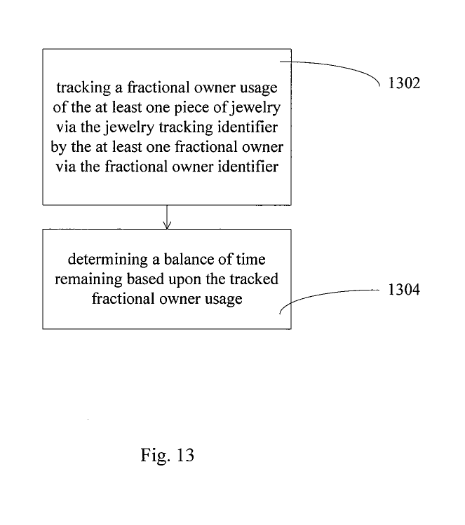

FIG. 13 illustrates tracking, 1302, a fractional owner usage of the at least one piece of jewelry via the jewelry tracking identifier by the at least one fractional owner via the fractional owner identifier, and determining, 1304, a balance of time remaining based upon the tracked fractional owner usage.

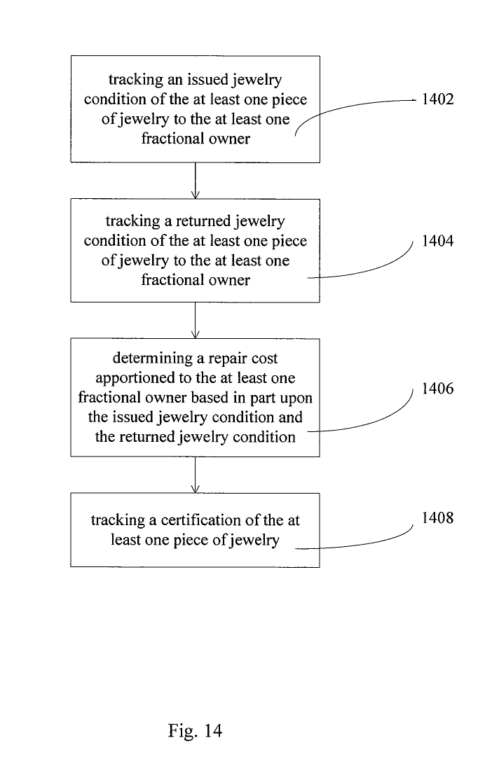

FIG. 14 illustrates the steps of tracking, 1402, an issued jewelry condition of the at least one piece of jewelry to the at least one fractional owner, tracking, 1404, a returned jewelry condition of the at least one piece of jewelry to the at least one fractional owner, and determining, 1406, a repair cost apportioned to the at least one fractional owner based in part upon the issued jewelry condition and the returned jewelry condition may be executed. For example, if the jewelry is returned in a damaged or otherwise lesser condition than when the jewelry is issued, the fractional owner is deemed responsible for at least part of the cost for cleaning or repair. Thus, an estimate, bill, or the like from a cleaning or repair technician or service is input to the system, and the apportionment of the cost is determined. Additionally the step of tracking, 1408, a certification of the at least one piece of jewelry may be executed by the computer.

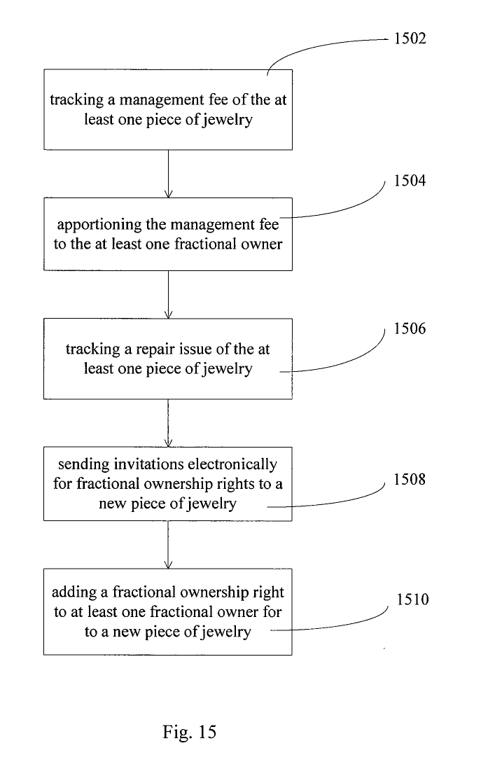

FIG. 15 illustrates the steps of tracking, 1502, a management fee of the at least one piece of jewelry and apportioning, 1504, the management fee to the at least one fractional owner. Management fees, which can include fees for maintaining the system described herein, may be apportioned among fractional owners based on ownership interest of each fractional owner, frequency of usage, or the like. The steps may also include tracking, 1506, a repair issue of the at least one piece of jewelry, such as the location of the piece of jewelry during repair, the status of the repair, cost, and the like. The steps may also include sending, 1508, invitations electronically for fractional ownership rights to a new piece of jewelry and adding, 1510, a fractional ownership right to at least one fractional owner for to a new piece of jewelry. For example, invitations can be sent to system users notifying that a new piece of jewelry has arrived and ownership rights are available for purchase.

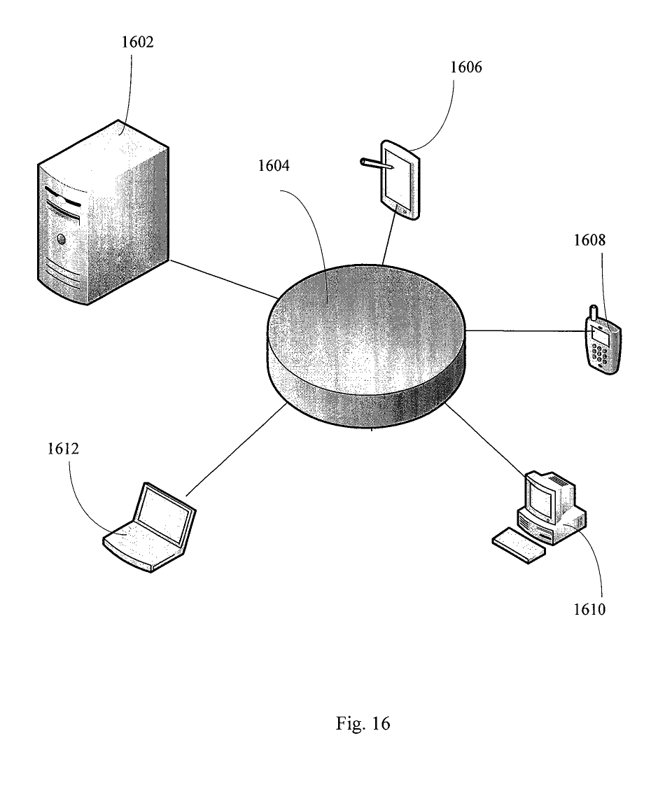

FIG. 16 illustrates the management and control system server 1602 connected to the internet 1604 or the like. The management and control system may be accessed in a wired or wireless fashion by a tablet PC, 1606, a cellular phone, 1608, a personal computer, 1610, a laptop computer 1612 or the like.

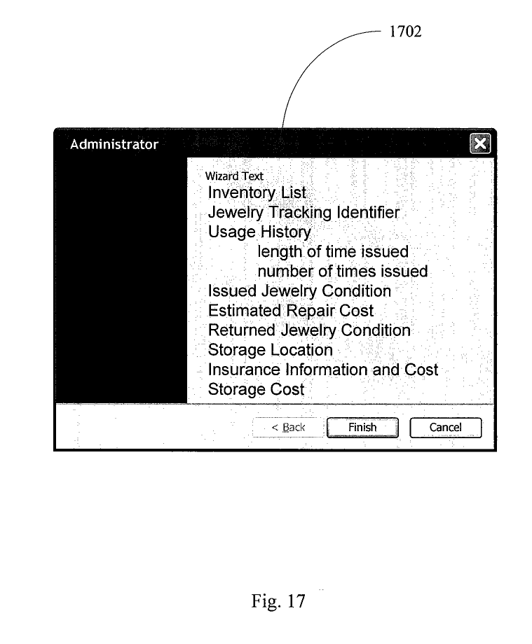

FIG. 17 illustrates that the management and control system may be managed by a system administrator having access to items such as, 1702, an inventory list, a jewelry tracking identifier, a usage history, a length of time issued, a number of times issued, an issued jewelry condition, a returned jewelry condition, an estimated repair cost, a storage location, insurance information and cost, storage cost and the like.

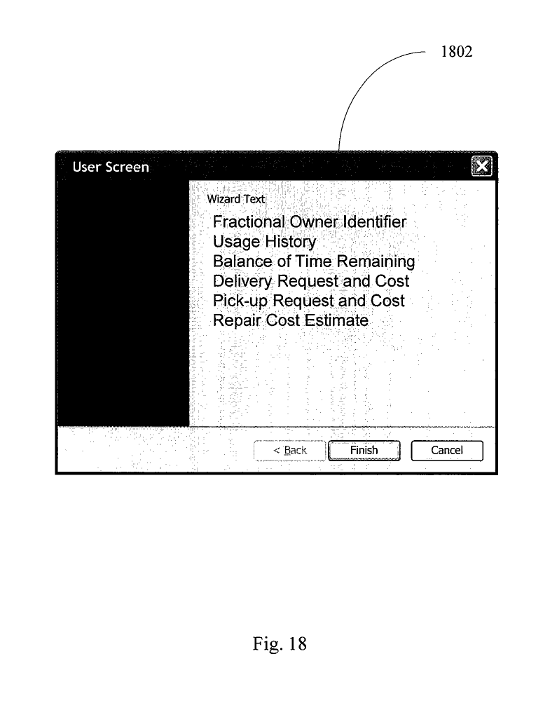

FIG. 18 illustrates that the management and control system may be accessed by a user or fractional owner. The system will allow access to items such as, 1802, a fractional owner identifier, a usage history, a balance of time remaining, a delivery request and estimated cost, a pick up request and estimated cost, a repair cost estimate and the like.

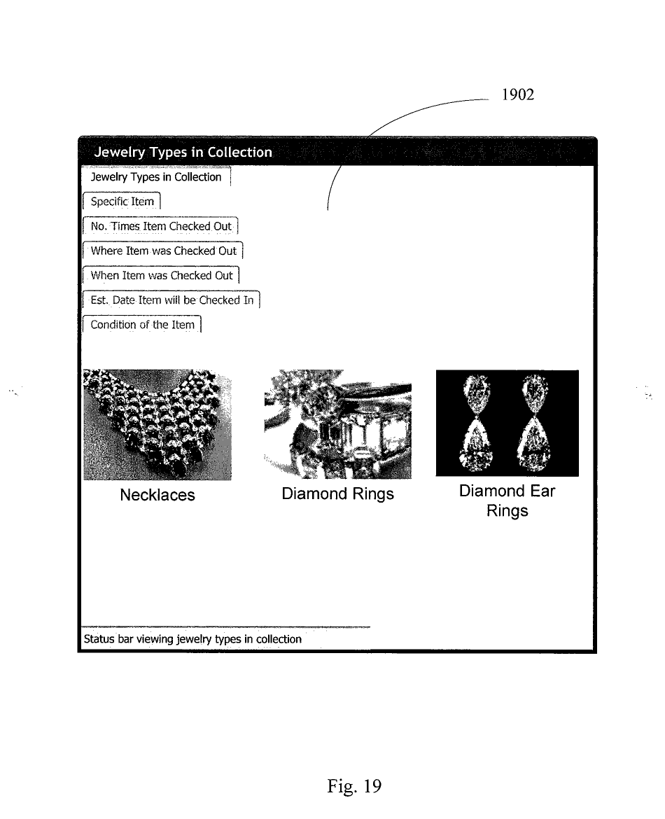

FIG. 19 illustrates that the management and control system may be accessed by a user or fractional owner. The system will allow access and on-line review of various types of jewelry such as necklaces, diamond rings and ear rings as shown in 1902.

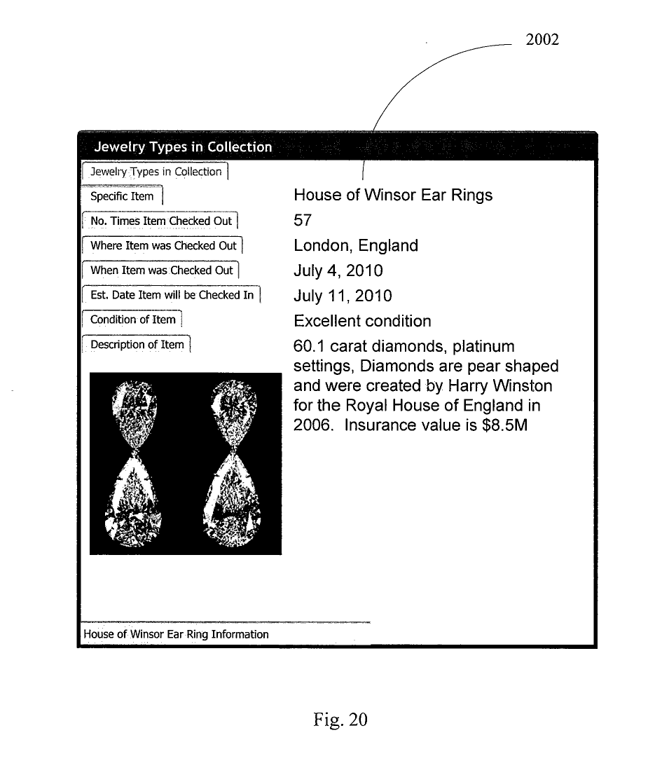

FIG. 20 illustrates that the management and control system may be accessed by a user or fractional owner. The system allows the user or fractional owner to review the collection and individual pieces on line, and shows items such as, how many times that piece of jewelry has been checked out by any client, where the item was checked out, such as city, state and nation, when the item was checked out, the estimated time of arrival of the piece of jewelry and its description such as its size, characteristics, age and origin as shown in 2002.

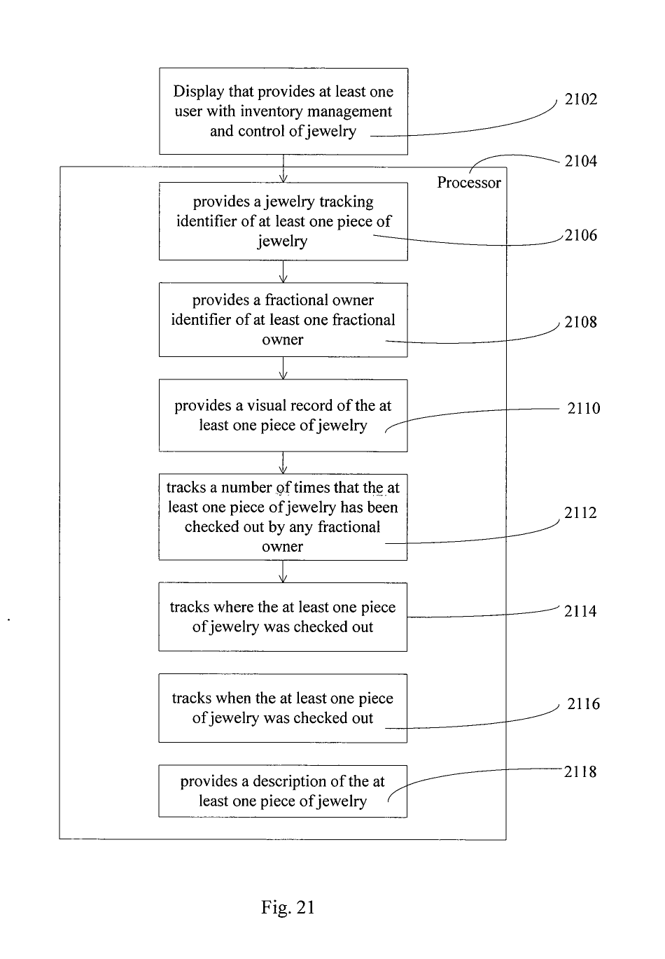

FIG. 21 illustrates that the system for inventory management and control of a jewelry collection has a display 2102 that provides at least one user with inventory management and control of a jewelry collection, and a processor 2104 communicably coupled to the display. The processor, provides a jewelry tracking identifier 2106 of at least one piece of jewelry, provides a fractional owner identifier 2108 of at least one fractional owner and provides a visual record 2110 of the at least one piece of jewelry. The system also tracks 2112 a number of times that the at least one piece of jewelry has been checked out by any fractional owner, tracks 2114 where the at least one piece of jewelry was checked out, tracks 2116 when the at least one piece of jewelry was checked out and provides 2118 a description of the at least one piece of jewelry. The system may be accessed online by internet, smart phone or the like. The system may provide at least one descriptor selected from the group consisting of jewel size, jewel clarity, jewel color, age, origin and creator of the jewelry.

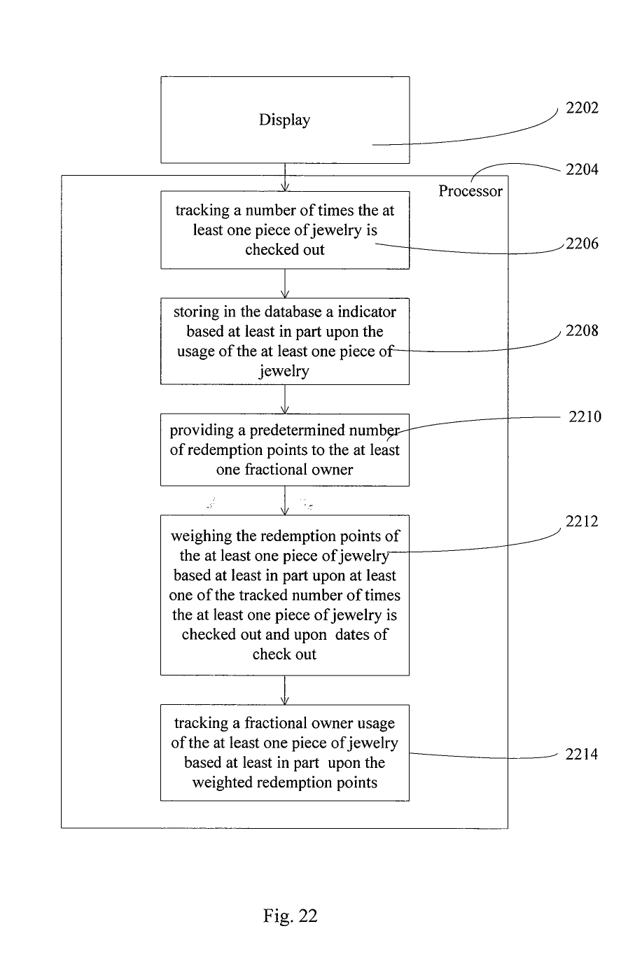

FIG. 22 illustrates that the system for inventory management and control of a jewelry collection has a display 2202 that provides at least one user with inventory management and control of a jewelry collection, and a processor 2204 communicably coupled to the display. The processor executes the steps of tracking, 2206, a number of times the at least one piece of jewelry is checked out, storing, 2208, in the database a indicator based at least in part upon the usage of the at least one piece of jewelry and providing, 2210 a predetermined number of redemption points to the at least one fractional owner. The processor additionally executes the steps of weighing, 2212, the redemption points of the at least one piece of jewelry based at least in part upon at least one of the tracked number of times the at least one piece of jewelry is checked out and upon dates of check out and tracking, 2214, a fractional owner usage of the at least one piece of jewelry based at least in part upon the weighted redemption points.

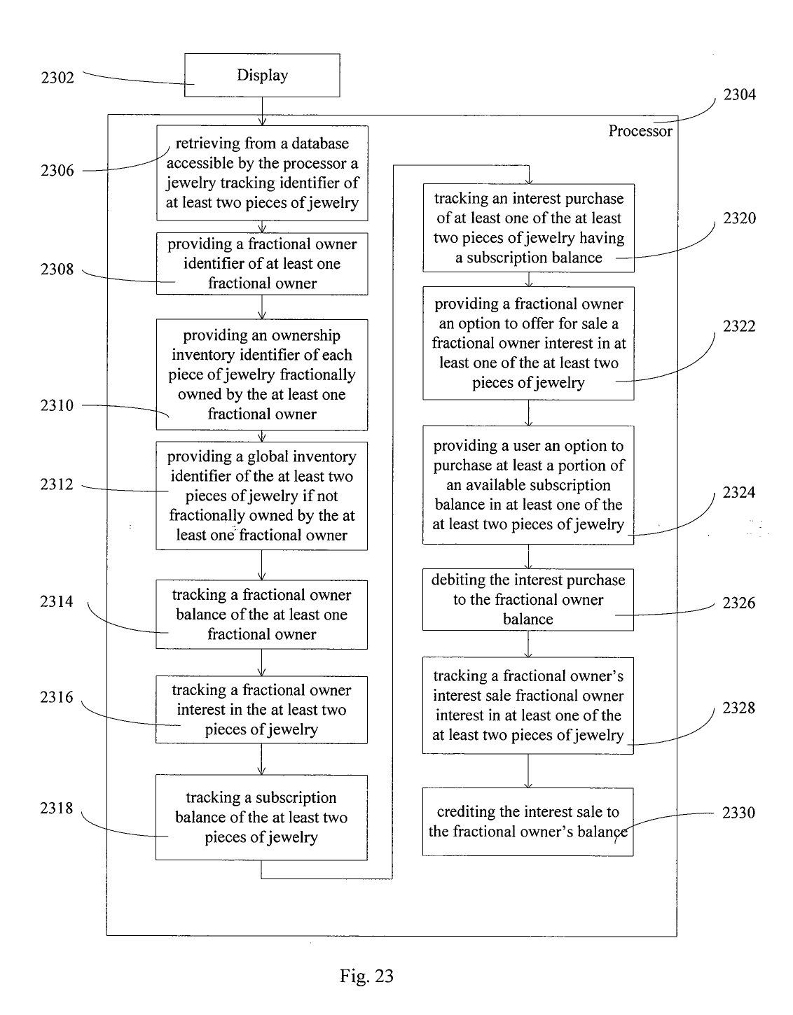

FIG. 23 illustrates that the system for inventory management and control of a jewelry collection has a display, 2302, that provides at least one user with inventory management and control of a jewelry collection, and a processor, 2304, communicably coupled to the display. The processor performs the actions of retrieving, 2306, from a database accessible by said processor a jewelry tracking identifier of at least two pieces of jewelry, providing, 2308, a fractional owner identifier of at least one fractional owner, providing, 2310, an ownership inventory identifier of each piece of jewelry fractionally owned by said at least one fractional owner and providing, 2312, a global inventory identifier of said at least two pieces of jewelry if not fractionally owned by said at least one fractional owner. The processor also performs the actions of tracking, 2314, a fractional owner balance of said at least one fractional owner, tracking, 2316, a fractional owner interest in said at least two pieces of jewelry, tracking, 2318, a subscription balance of said at least two pieces of jewelry and tracking, 2320, an interest purchase of at least one of said at least two pieces of jewelry having a subscription balance. Additionally, the processor performs the actions of providing, 2322, a fractional owner an option to offer for sale a fractional owner interest in at least one of said at least two pieces of jewelry, providing, 2324, a user an option to purchase at least a portion of an available subscription balance in at least one of said at least two pieces of jewelry, debiting, 2326, said interest purchase to said fractional owner balance, tracking, 2328, a fractional owner's interest sale fractional owner interest in at least one of said at least two pieces of jewelry, and crediting, 2330, said interest sale to said fractional owner's balance.

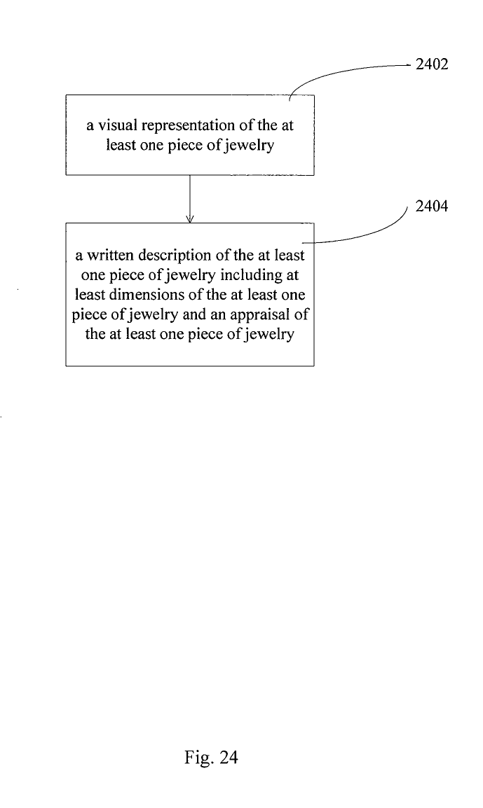

FIG. 24 illustrates that the database may store, 2402, a visual representation of the at least one piece of the two pieces of jewelry, and a written description, 2404, of the at least one piece of the two pieces of jewelry including at least dimensions of the at least one piece of the two pieces of jewelry and an appraisal of the at least one piece of jewelry.

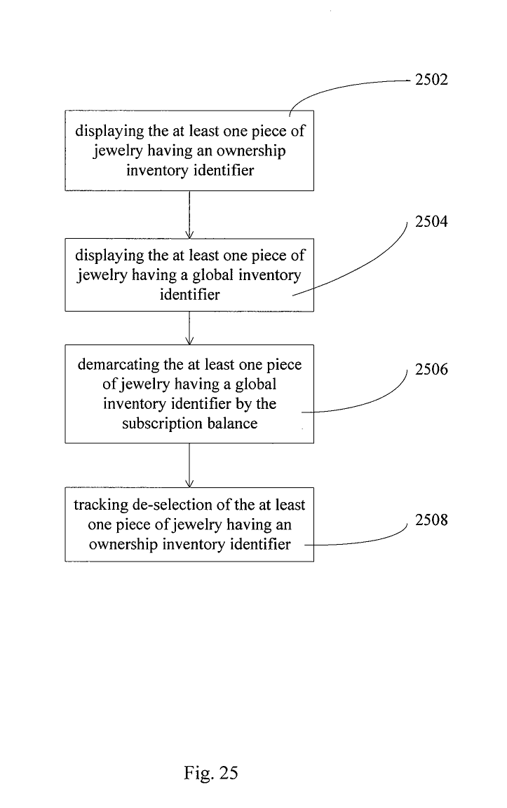

FIG. 25 illustrates that the system processor may further perform the actions of displaying, 2502, the at least one piece of the two pieces of jewelry having an ownership inventory identifier, displaying, 2504, the at least one piece of the two pieces of jewelry having a global inventory identifier, demarcating, 2506, the at least one piece of the two pieces of jewelry having a global inventory identifier by the subscription balance, and tracking, 2508, de-selection of the at least one piece of the two pieces of jewelry having an ownership inventory identifier.

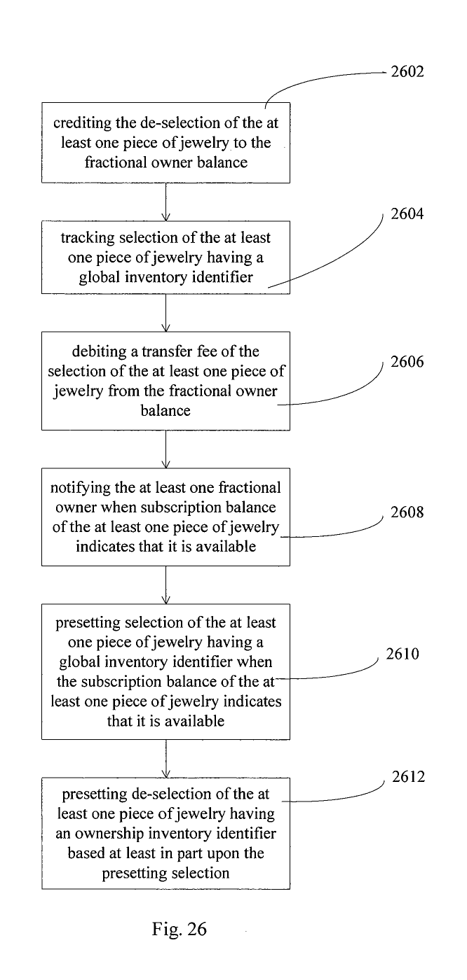

FIG. 26 illustrates that the system processor may also perform the actions of crediting, 2602, the de-selection of the at least one piece of the two pieces of jewelry to the fractional owner balance, tracking, 2604, selection of the at least one piece of the two pieces of jewelry having a global inventory identifier, debiting, 2606, a transfer fee of the selection of the at least one piece of the two pieces of jewelry from the fractional owner balance, notifying, 2608, the at least one fractional owner when subscription balance of the at least one piece of the two pieces of jewelry indicates that it is available, presetting, 2610, selection of the at least one piece of the two pieces of jewelry having a global inventory identifier when the subscription balance of the at least one piece of the two pieces of jewelry indicates that it is available, and presetting, 2612, de-selection of the at least one piece of the two pieces of jewelry having an ownership inventory identifier based at least in part upon the presetting selection.

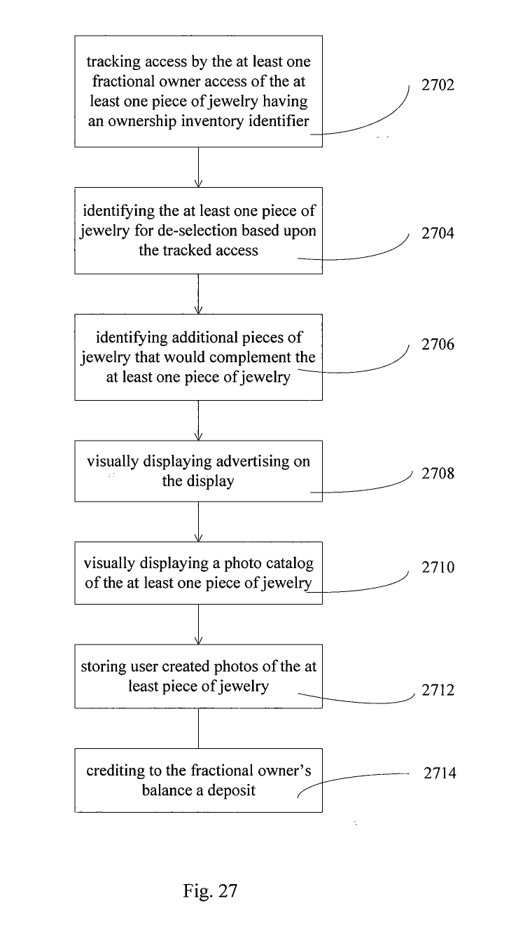

FIG. 27 illustrates that the system processor may also perform the actions of tracking, 2702, access by the at least one fractional owner access of the at least one piece of the two pieces of jewelry having an ownership inventory identifier, identifying, 2704, the at least one piece of the two pieces of jewelry for de-selection based upon the tracked access, identifying, 2706, additional pieces of jewelry that would complement the at least one piece of the two pieces of jewelry, visually displaying, 2708, advertising on the display, visually displaying, 2710, a photo catalog of the at least one piece of the two pieces of jewelry, storing, 2712, user created photos of the at least piece of jewelry and crediting, 2714 to the fractional owner's balance a deposit, via credit card, wire transfer, check or the like.

With respect to the above description then, it is to be realized that all equivalent relationships to those illustrated in the drawings and described in the specification are intended to be encompassed by the present embodiments. Therefore, the foregoing is considered as illustrative only of the principles of one of the embodiments. Further, since numerous modifications and changes will readily occur to those skilled in the art, it is not desired to limit any embodiment to the exact construction and operation shown and described, and accordingly, all suitable modifications and equivalents may be resorted to, falling within the scope of one of the embodiments. It is foreseen that the elements from each of the embodiments may be interchanged.

What is claimed is:

1. A method for inventory management and control of a jewelry collection, the method comprising:
providing a jewelry tracking identifier for at least one piece of jewelry;
providing a user identifier of at least one user;
tracking a usage, by the at least one user of the at least one piece of jewelry via the jewelry tracking identifier and the user identifier; and
determining a balance of time remaining for use of the at least one piece of jewelry by the at least one user based at least in part upon the tracked usage.

2. The method of claim 1 further comprising:
tracking an issued jewelry condition of the at least one piece of jewelry delivered to the at least one user; and
tracking a returned jewelry condition of the at least one piece of jewelry returned by the at least one user.

3. The method of claim 1 further comprising:
tracking an inventory of multiple pieces of jewelry.

4. The method of claim 1 further comprising:
establishing a checkout time and a check-in time for the at least one piece of jewelry;
saving in a database a representation of the checkout and check-in times of the at least one piece of jewelry; and
tracking a number of times the at least one piece of jewelry is checked out.

5. The method of claim 1 wherein the at least one user is a fractional owner of the at least one piece of jewelry.

6. A method for inventory management and control of a jewelry collection, the method comprising:
providing a jewelry tracking identifier for at least one piece of jewelry;
providing a fractional owner identifier of at least one fractional owner for the at least one piece of jewelry;
tracking a fractional owner usage of the at least one piece of jewelry by the at least one fractional owner via the jewelry tracking identifier and the fractional owner identifier;
tracking an inventory of the at least one piece of jewelry; and
determining a balance of time remaining based upon the tracked fractional owner usage.

7. The method of claim 6 further comprising:
tracking an issued jewelry condition of the at least one piece of jewelry to the at least one fractional owner; and
tracking a returned jewelry condition of the at least one piece of jewelry to the at least one fractional owner.

8. The method of claim 6 further comprising:
tracking a number of times the at least one piece of jewelry is checked out.

9. The method of claim 8 further comprising:
providing to a user an indication of demand for the at least one piece of jewelry.

10. The method of claim 8 further comprising:
identifying the at least one piece of jewelry if the number of times the at least one piece of jewelry is checked out is below a predetermined level within a predetermined time interval.

11. The method of claim 6 further comprising:
tracking a storage location of the at least one piece of jewelry.

12. The method of claim 6 further comprising:
tracking insurance information of the at least one piece of jewelry.

13. The method of claim 6 further comprising:
receiving a delivery command pertaining to the at least one piece of jewelry.

14. The method of claim 13 further comprising:
tracking delivery of the at least one piece of jewelry.

15. The method of claim 6 further comprising:
receiving a pick-up command pertaining to the at least one piece of jewelry.

16. The method of claim 15 further comprising:
tracking return of the at least one piece of jewelry.

17. The method as in claim 6 further comprising:
transmitting to a delivery service a pick-up command;
receiving from the delivery service tracking information; and thereafter
transmitting to the fractional owner a confirmation e-mail with the tracking information.

18. A method as in claim 6 further comprising:
determining from an inputted checkout date, a probable return check-in date;
querying a database entry associated with the at least one piece of jewelry or the at least one fractional owner;
determining if the at least one piece of jewelry has been checked-in; and
based upon the determination that the at least one piece of jewelry has not been checked-in, sending to the at least one fractional owner a reminder message.

19. The method of claim 6 further comprising:
sending to a user an electronic reminder that an appraisal needs to be performed for the at least one piece of jewelry.

20. A system for inventory management and control of a jewelry collection, the system comprising:
a display that provides at least one user with inventory management and control of a jewelry collection; and
a processor communicably coupled to the display, wherein the processor:
provides a jewelry tracking identifier of at least one piece of jewelry,
provides a fractional owner identifier of at least one fractional owner,
tracks a fractional owner usage of the at least one piece of jewelry by the at least one fractional owner via the jewelry tracking identifier and the fractional owner identifier,
tracks an inventory of the at least one piece of jewelry, and
determines a balance of time remaining based upon the tracked fractional owner usage.

21. The system of claim 20 wherein the processor further tracks a number of times the at least one piece of jewelry is checked out.

22. The system of claim 20 wherein the processor further indentifies the at least one piece of jewelry if the number of times the at least one piece of jewelry is checked out is below a predetermined level within a predetermined time interval.

23. A system for inventory management and control of a jewelry collection, the system comprising:
a display that provides at least one user with inventory management and control of a jewelry collection; and
a processor communicably coupled to the display, wherein the processor:
retrieves from a database accessible by the processor a jewelry tracking identifier of at least one piece of jewelry,
provides a fractional owner identifier of at least one fractional owner,
tracks a fractional owner's usage by the at least one fractional owner of the at least one piece of jewelry via the retrieved jewelry tracking identifier and at least in part based on the retrieved fractional owner identifier,
tracks an inventory location of the at least one piece of jewelry, and
determines a balance of time remaining based upon the tracked fractional owner usage.

24. The system of claim 23 wherein the processor further:
tracks a number of times the at least one piece of jewelry is checked out,
stores in the database an indicator based at least in part upon the usage of the at least one piece of jewelry,
provides a predetermined number of redemption points to the at least one fractional owner,
weighs the redemption points of the at least one piece of jewelry based at least in part upon at least one of the tracked number of times the at least one piece of jewelry is checked out and upon dates of check out, and
tracks a fractional owner usage of the at least one piece of jewelry based at least in part upon the weighted redemption points.

25. A computer usable medium comprising computer readable instructions for controlling a computer to enable inventory management and control of a jewelry collection executing the steps of:
providing a jewelry tracking identifier of at least one piece of jewelry;
providing a fractional owner identifier of at least one fractional owner;
tracking location information of the at least one piece of jewelry based upon the jewelry tracking identifier; and
determining a storage cost of the at least one piece of jewelry apportioned to the at least one fractional owner based upon the fractional owner identifier and the tracked location information.

26. The computer usable medium of claim 25 further executing the steps of:
tracking a usage of the at least one piece of jewelry by a user via the jewelry tracking identifier and the at least one fractional owner identifier;
tracking an insurance cost of the at least one piece of jewelry; and
apportioning the insurance cost to the at least one fractional owner based in part upon the tracked usage.

27. The computer usable medium of claim 25 further executing the steps of:
receiving a delivery command of the at least one piece of jewelry; and
determining a delivery cost based in part upon a delivery location of the at least one fractional owner.

28. The computer usable medium of claim 25 further executing the steps of:
receiving a retrieval command of the at least one piece of jewelry; and
determining a retrieval cost based in part upon a retrieval location of the at least one fractional owner.

29. The computer usable medium of claim 25 further executing the steps of:
tracking a fractional owner usage of the at least one piece of jewelry by the at least one fractional owner via the jewelry tracking identifier and the fractional owner identifier; and
determining a balance of time remaining based upon the tracked fractional owner usage.

30. The computer usable medium of claim 25 further executing the steps of:
tracking an issued jewelry condition of the at least one piece of jewelry to the at least one fractional owner;
tracking a returned jewelry condition of the at least one piece of jewelry to the at least one fractional owner; and
determining a repair cost apportioned to the at least one fractional owner based in part upon the issued jewelry condition and the returned jewelry condition.

31. The computer usable medium of claim 25 further executing the steps of:
tracking a certification of the at least one piece of jewelry.

32. The computer usable medium of claim 25 further executing the steps of:
tracking a management fee of the at least one piece of jewelry; and
apportioning the management fee to the at least one fractional owner.

33. The computer usable medium of claim 25 further executing the steps of:
tracking a repair issue of the at least one piece of jewelry.

34. The computer usable medium of claim 25 further executing the steps of:
sending invitations electronically for fractional ownership rights to a new piece of jewelry.

35. The computer usable medium of claim 25 further executing the steps of:
adding a fractional ownership right to at least one fractional owner for a new piece of jewelry.

36. A system for inventory management and control of a jewelry collection, the system comprising:
a display that provides at least one user with inventory management and control of a jewelry collection; and
a processor communicably coupled to the display, wherein the processor:
provides a jewelry tracking identifier of at least one piece of jewelry,
provides a fractional owner identifier of at least one fractional owner,
provides a visual record of the at least one piece of jewelry,
tracks a number of times that the at least one piece of jewelry has been checked out by any fractional owner,
tracks where the at least one piece of jewelry was checked out;
tracks when the at least one piece of jewelry was checked out; and
provides a description of the at least one piece of jewelry.

37. The computer usable medium of claim 36 wherein the description provides at least one of jewel size, jewel clarity, jewel color, age, origin or creator.

38. A system for inventory management and control of a jewelry collection, the system comprising:
a display that provides at least one fractional owner with inventory management and control of a jewelry collection; and
a processor communicably coupled to the display, wherein the processor:
retrieves from a database accessible by the processor a jewelry tracking identifier of at least two pieces of jewelry,
provides a fractional owner identifier of at least one fractional owner,
provides an ownership inventory identifier of each piece of jewelry fractionally owned by the at least one fractional owner,
provides a global inventory identifier of the at least two pieces of jewelry if not fractionally owned by the at least one fractional owner,
tracks a fractional owner balance of the at least one fractional owner,
tracks a fractional owner interest in the at least two pieces of jewelry,
tracks a subscription balance of the at least two pieces of jewelry,
tracks an interest purchase of at least one of the at least two pieces of jewelry having a subscription balance,
provides a fractional owner an option to offer for sale a fractional owner interest in at least one of the at least two pieces of jewelry,
provides a user an option to purchase at least a portion of an available subscription balance in at least one of the at least two pieces of jewelry,
debits the interest purchase to the fractional owner balance,
tracks a fractional owner's interest sale fractional owner interest in at least one of the at least two pieces of jewelry, and
credits the interest sale to the fractional owner's balance.

39. The system of claim 38 wherein the database stores:
a visual representation of the at least one of the at least two pieces of jewelry, and
a written description of the at least one of the at least two pieces of jewelry including at least dimensions of the at least one piece of jewelry and an appraisal of the at least one piece of jewelry.

40. The system of claim 38 wherein the processor further:
displays the at least one of the at least two pieces of jewelry having an ownership inventory identifier,
displays the at least one of the at least two pieces of jewelry having a global inventory identifier,
demarcates the at least one of the at least two pieces of jewelry having a global inventory identifier by the subscription balance.

41. The system of claim 38 wherein the processor further:
tracks de-selection of the at least one of the at least two pieces of jewelry having an ownership inventory identifier,
credits the de-selection of the at least one of the at least two pieces of jewelry to the fractional owner balance.

42. The system of claim 41 wherein the processor further:
tracks selection of the at least one of the at least two pieces of jewelry having a global inventory identifier,
debits a transfer fee of the selection of the at least one of the at least two pieces of jewelry from the fractional owner balance.

43. The system of claim 38 wherein the processor further:
notifyies the at least one fractional owner when subscription balance of the at least one of the at least two pieces of jewelry indicates that it is available.

44. The system of claim 38 wherein the processor further:
presets selection of the at least one of the at least two pieces of jewelry having a global inventory identifier when the subscription balance of the at least one of the at least two pieces of jewelry indicates that it is available, and
presets de-selection of the at least one of the at least two pieces of jewelry having an ownership inventory identifier based at least in part upon the presetting selection.

45. The system of claim 38 wherein the processor further:
tracks access by the at least one fractional owner of the at least one piece of jewelry having an ownership inventory identifier.

46. The system of claim 45 wherein the processor further:
identifies the at least one of the at least two pieces of jewelry for de-selection based upon the tracked access.

47. The system of claim 38 wherein the processor further:
identifies additional pieces of jewelry that would complement the at least one of the at least two pieces of jewelry.

48. The system of claim 38 wherein the processor further:
visually displays advertising on the display.

49. The system of claim 38 wherein the processor further:
visually displays a photo catalog of the at least one of the at least two pieces of jewelry.

50. The system of claim 49 wherein the processor further:
stores user created photos of the at least one of the at least two pieces of jewelry.

51. The system of claim 38 wherein the processor further:
credits to the fractional owner's balance a deposit.

52. The system of claim 51 wherein the deposit may be deposited via a credit card.

53. The system of claim 51 wherein the deposit may be deposited via a wire transfer.

54. The system of claim 51 wherein the deposit may be deposited via a check.
